(19) United States
(12) Patent Application Publication
(10) Pub. No.: US 2006/0143216 A1
(43) Pub. Date: Jun. 29, 2006

(54) Method and system for integrating multimodal interpretations

(76) Inventors: Anurag K. Gupta, Palatine, IL (US); Tasos Anastasakos, San Jose, CA (US)

Correspondence Address: MOTOROLA, INC., 1303 EAST ALGONQUIN ROAD, IL01/3RD, SCHAUMBURG, IL, 60196, US

(21) Appl. No.: 11/021,407

(22) Filed: Dec. 23, 2004

(51) Int. Cl. G06F 17/00

(52) U.S. Cl. 707/102

(57) ABSTRACT

A method and a system for integrating multimodal interpretations (MMIs) in user inputs to a data processing system (100) are provided. The method includes generating (603) a set of MMIs, based on the user inputs collected during a turn. The set of MMIs includes at least semantic relationship function, the semantic relationship function denoting a semantic relationship between values determined from the user inputs entered through one or more of the at least one input modality, the semantic relationship function comprising at least one semantic operator. The method further includes generating (604) sets of joint MMIs. Each set of joint MMIs includes MMIs of semantically compatible types. The method further includes resolving (606) the reference values of the references of each set of joint MMIs to generate corresponding sets of reference resolved MMIs. The method further includes generating (608) an integrated MMI for each set of reference-resolved MMIs. The generation of the integrated MMI is carried out by using semantic operator based fusion.

### RELATED APPLICATION

This application is related to the following applications: Co-pending U.S. patent application Ser. No. 10/853850, entitled “Method And Apparatus For Classifying And Ranking Interpretations For Multimodal Input Fusion”, filed on May 25, 2004, and Co-pending U.S. Patent Application (Serial Number Unknown), entitled “Method and System for Resolving Cross-Modal References in User Inputs”, filed concurrently with this Application, both applications assigned to the assignee hereof.

### FIELD OF THE INVENTION

The present invention relates to the field of software, and more specifically, it relates to integration of multimodal interpretations (MMIs) generated from user inputs.

### BACKGROUND

Dialog systems are systems that allow a user to interact with a data processing system to perform tasks such as retrieving information, conducting transactions, and other such problem solving tasks. A dialog system can use several modalities for interaction. Examples of modalities include speech, gesture, touch, handwriting, etc. User and data processing system interactions in dialog systems are enhanced by employing multiple modalities. The dialog systems using multiple modalities for user-data processing system interaction are referred to as multimodal systems. The user interacts with a multimodal system using a dialog based user interface. A set of interactions of the user and the multimodal system is referred to as a dialog. Each interaction is referred to as a user turn. The information provided by either the user or the multimodal system in such multimodal interactive dialog systems is referred to as a context of the dialog.

In multimodal interactive dialog systems, the user provides inputs through multiple modalities, such as speech, touch, etc. The user inputs are represented by the data processing system in the form of a multimodal interpretation (MMI). The user inputs from multiple modalities, i.e., multimodal inputs, are combined into a single integrated input, for the data processing system to take a corresponding action. The integration of multimodal inputs depends upon semantic relationship functions such as concept-level and content-level relationships between the multimodal inputs. The concept-level relationship refers to the relationship between tasks and concepts. For example, the integration of two MMIs representing entities of the same type (e.g., a hotel) should result in an MMI containing a collection of both the entities. The content-level relationship is determined by the values of corresponding attributes in the MMIs, which have typically been combined by using the content-level relationship. Examples of content-level relationships in known multi-modal systems include complementary, redundant, logical and overlaying relationships. In a complementary relationship, each MMI comprises values of different attributes of user inputs. In a redundant relationship, each MMI has the same value for the same attributes. Further, content-level relationships can be a logical or an overlaying relationship. In a logical relationship, the values in the MMI are linked logically and are combined according to the logical relationship. In an overlaying relationship, a value in one MMI replaces values in other MMIs. Each content-level relationship uses a specific method to integrate the values of the corresponding attributes from multiple MMIs. An MMI may have multiple content-level relationships with another MMI at the same time. For example, two MMIs can have one or more attributes with complementary content-level relationship values and one or more attributes with redundant content-level relationship.

A known method for integrating MMIs based on Unification is useful but is only applicable if user inputs from multiple modalities are either redundant or complementary. The method does not take into consideration other content-level relationships such as overlaying relationship. In such cases, the integration operation fails and an integrated MMI cannot be formed. Further, content-level relationships are not explicitly represented in MMIs generated by using known methods.

### BRIEF DESCRIPTION OF THE DRAWINGS

Various embodiments of the invention will hereinafter be described in conjunction with the appended drawings provided to illustrate and not to limit the invention, wherein like designations denote like elements, and in which:

FIG. 1 is a data processing system for integrating multimodal interpretations, in accordance with some embodiments of the present invention;

FIG. 2 depicts the result of integrating an MMI of type ‘Hotel’, with aggregate content, with an MMI of type ‘DisplayHotel’, in accordance with some embodiments of the present invention;

FIG. 3 depicts the result of integrating two ‘CreateRoute’ MMIs with semantic operators, in accordance with some embodiments of the present invention;

FIG. 4 depicts the result of integrating a ‘CreateRoute’ MMI with a ‘StreetAddress’ MMI, which is a sub-type of a complex attribute of the ‘CreateRout’ MMI, in accordance with some embodiments of the present invention;

FIG. 5 illustrates the ambiguity resolution of an atomic attribute when two MMIs are integrated, in accordance with some embodiments of the present invention;

FIG. 6 is a flowchart illustrating a method for integrating multimodal interpretations, in accordance with some embodiments of the present invention;

FIG. 7 is a flowchart illustrating a method for generating an aggregate type integrated MMI, in which semantic operators are not used, in accordance with some embodiments of the present invention;

FIG. 8 is a flowchart illustrating yet another method for integrating MMIs, in accordance with some embodiments of the present invention; and

FIG. 9 illustrates an electronic device for the integration of MMIs, in accordance with some embodiments of the present invention.

### DETAILED DESCRIPTION OF THE INVENTION

Before describing in detail the particular multimodal integration method and system in accordance with the present invention, it should be observed that the present invention resides primarily in combinations of method steps and system components related to multimodal integration technique. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

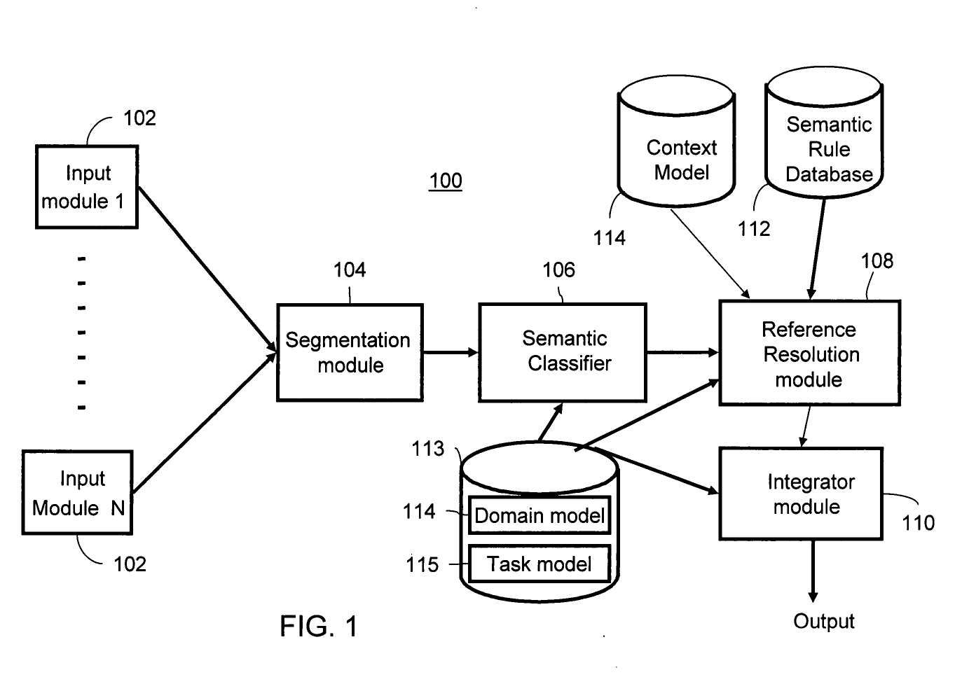

Referring to FIG. 1, a block diagram shows a data processing system 100 for integrating MMIs generated from user inputs to the data processing system 100 in accordance with some embodiments of the present invention. The data processing system 100 comprises at least one input module 102, a segmentation module 104, a semantic classifier 106, a reference resolution module 108, an integrator module 110, a semantic rule database 112, and a domain and task model 113. The domain and task model 113 comprises a domain model 114 and a task model 115. The segmentation module 104, the semantic classifier 106, the reference resolution module 108, and the integrator module 110 may collectively be referred to as a multimodal input fusion module, or MMIF module.

A user enters inputs through the input modules 102. Examples of the input module 102 include a touch screen, a keypad, a microphone, and other such devices. A combination of these devices may also be used for entering the user inputs. Each user input is interpreted and an MMI is generated. The MMI is represented as a Multimodal Feature Structure (MMFS), which can represent either a concept or a task. A MMFS contains semantic content and predefined attribute-value pairs such as name of the modality and the span of time during which the user provided the input that generated the MMI. The semantic content of a MMFS is a collection of attribute-value pairs, and semantic relationships between attributes, domain concepts and tasks represented by MMIs. The semantic content within a MMFS is represented as a Type Feature Structure (TFS) or as a combination of TFSs.

A MMFS is generated for each MMI. The semantic content of a MMFS (i.e. a TFS) comprises at least one semantic operator and at least one attribute. Each attribute within a TFS is typed, i.e., an attribute of a TFS is defined to contain values of a given type (e.g., Boolean, string, etc.). An attribute within a TFS may be atomic, for example, a string, or a number, or complex, for example, a collection of attribute-value pairs. The value of both the atomic and complex attributes can comprise a semantic relationship function with zero or more function parameters. The atomic and complex attributes may have multiple values when the values occur within a semantic relationship function. If the semantic relationship function is not explicitly specified, multiple values of an attribute are treated as part of a list. Each TFS, except those TFSs that are nested within other TFSs as values of its complex attributes, comprise two aspects known as ‘Reference Order’ and a ‘Confidence Score’.

The Reference Order is an ordered list of all the reference variables within a TFS. It represents the order in which the referential expressions were issued. A referential expression is a user input that has at least one reference. A reference variable is used to represent each referential expression given by a user. A reference variable, set as the value of an attribute, denotes that the attribute was referred to but its value was not instantiated. A reference variable is resolved by binding it to an MMI, which is either of the same type or a sub-type of the type of the complex attribute. The reference variable can also be shared between multiple attributes of an MMI. Each reference variable comprises information about the number of referents required to resolve the reference variable. The number can be a positive integer or undefined (meaning the user did not specify a definite number for the number of required referents, e.g., when a user refers to something by saying “these”). Further, each reference variable comprises information about the type of referents (i.e. MMIs) required to resolve the reference variable. In addition, a reference variable can be deictic or anaphoric. A deictic reference specifies either the identity, or the spatial or temporal location from the perspective of a user, for example, if a multimodal navigation application is displaying a number of hotels, then a user saying, “I want to see these hotels”, and selecting one or more hotels using a gesture represents a deictic reference to the selected hotels. Anaphoric references are references that use a pronoun that refers to an antecedent. An example of an anaphoric reference is the user input, “Get information on the last two ‘hotels’”. In this example, the hotels are referred to anaphorically with the word ‘last’. The reference variable representing the earliest referential expression is the first on a list of reference variables. If a TFS does not have any reference variables, the Reference Order attribute is empty. An example of a Reference Order where a user says, “I want to go from here to there via here”, is given below.

TABLE 1
$[ \begin{matrix}Modality \text{:} Speech \\ start Time \text{:} \text{10:15:19.12, 15 May 2002} \\ end Time \text{: 10:15:21.03, 15 May 2002} \\ content \text{:} [ \begin{matrix}\begin{matrix}\begin{matrix}\begin{matrix}type \text{:} Calculate Route via Waypoint \\ Reference\_Order \text{:} \$ref1 , Sref2 , Sref3\end{matrix} \\ source \text{:} \$ref1 ( deictic , 1 )\end{matrix} \\ waypoint \text{:} \$ref3 ( deictic , 1 )\end{matrix} \\ destination \text{:} \$ref2 ( deictic , 1 )\end{matrix} ]\end{matrix} ]$

In the above example, the user has made three references to three different objects: source, destination and waypoint. The references are represented using reference variables $ref1, $ref2, and $ref3 respectively. Assuming that the MMI used to represent the above user input has three features source, destination and waypoint—the value of the Reference_Order attribute will be ‘$ref1, $ref3, $ref2’. The MMI generated for the user input is shown in Table 1.

The confidence score is an estimate made by the input module 102 of the likelihood that the TFS accurately captures the meaning of the user input. For example, the confidence score could be very high for a keyboard input, but low for a voice input made in a noisy environment. These are not necessarily used in the embodiments of present invention described herein, or may be used in a manner not necessarily described herein.

The value of a complex attribute can be a reference variable, which is used to represent each referential expression given by a user. Further, the value of a complex attribute can be an instance of a sub-type of an attribute's type, as given above. Therefore, a complex attribute can have an empty value, or one or more complex values. As an example, a complex attribute's value can be an instance of a TFS, the type of which is the same as the attribute's type or is a sub-type of the attribute's type, a reference variable, or a semantic relationship function comprising an operator and zero or more values allowed for complex attributes. Similarly, an atomic attribute can have an empty value, or one or more atomic values, i.e., string, date, boolean or number corresponding to its type, or a semantic relationship function comprising an operator and zero or more values allowed for atomic attributes.

As described in the preceding paragraph, the value of an attribute in an MMI can be a semantic relationship function. A semantic relationship function comprises a semantic operator and the values provided in an input modality. A semantic operator defines the relationship between the values of attributes received in one or more input modalities. Examples of the semantic operators include ‘and’, ‘or’, ‘not’, ‘list’, ‘aggregat’, ‘ambiguous’ and ‘replace’. The ‘and’ semantic operator represents a logical ‘and’ relationship between the values, and accepts multiple values for all types of attributes. The ‘or’ semantic operator represents a logical ‘or’ relationship between the values, and accepts multiple values for all types of attributes. The ‘not’ semantic operator represents a logical ‘not’ relationship between the values, and accepts multiple values for complex attributes and a single value for simple attributes. The ‘list’ or ‘aggregate’ semantic operator represents a list of values of an attribute, and accepts multiple values for all types of attributes. The ‘ambiguous’ semantic operator represents a collection of ambiguous values of an attribute, and accepts multiple values for all types of attributes. The ‘replace’ semantic operator represents a function to replace the values of corresponding attribute in MMIs generated from user inputs given in other modalities, with the value contained within the semantic relationship function in the current input modality. The ‘replace’ semantic operator accepts a single value for all types of attributes. The semantic operators are further explained in conjunction with a ‘Hotel’ TFS in Table 2.

TABLE 2
$[ \begin{matrix}type \text{:} Hotel \\ Name \text{:} Sheraton \\ Amenities \text{:} list ( pool , gym )\end{matrix} ]$

The ‘Hotel’ TFS has attributes such as type, name and amenities. The amenities attribute is an atomic attribute of type string, which contains multiple values related using a ‘list’ semantic operator.

An explicit declaration of the semantic relationship function is possible by setting the value of an attribute to a semantic operator with one or more values. A value contained in a semantic relationship function can be another semantic relationship function, allowing nesting of semantic relationship functions. An example of an MMI, in which the value of an attribute is a semantic relationship function, is illustrated in Table 3.

Consider an example where the user says, “I want to go here or there whichever is quicker”. In this example, the destinations specified by the user have a logical ‘or’ relationship between them, and the values are the two references ‘here’ and ‘there’. An MMFS with a ‘CreateRoute’ TFS is generated, corresponding to the user input given in the speech input modality. The destination attribute in the ‘CreateRoute’ TFS is specified, using a semantic relationship function. The semantic operator for the semantic relationship function is the logical function ‘or’, and the parameters of the semantic relationship function are the two reference variables, each representing a reference. The user input does not explicitly specify a semantic relationship pertaining to the value of the ‘mode’ attribute, which defines the method for reaching an appropriate destination. Therefore, the ‘mode’ feature is assigned the value ‘quickest’.

TABLE 3
$[ \begin{matrix}type \text{:} CreateRoute \\ Reference\_Order \text{:} \$ref1 , \$ref2 \\ Confidence \text{:} 0.8 \\ Source \text{:} \\ Destination \text{:} or ( \$ref1 , \$ref2 ) \\ mode \text{:} quickest\end{matrix} ]$

Multiple TFSs can be generated within a MMFS from a single user input. In an embodiment of the invention, MMIs can be of two types—ambiguous and aggregate. An MMI is ambiguous when there are more than one TFSs generated within a MMFS, corresponding to a particular user input. An ambiguous MMI is generated because a single user input may have multiple meanings and an input module 102 may lack sufficient knowledge to disambiguate between the multiple meanings. In addition, a single user input may need to represent an aggregate of multiple domain concepts or tasks. Two semantic relationship functions can be used to relate multiple TFSs as a part of a MMFS. These semantic relationship functions are,
1. An ambiguous relationship, which implies that the TFSs are produced from the same user input and possibly only one out of them is the correct interpretation of the user input.

2. An aggregate relationship, which implies that the TFSs are produced from a single user input and they collectively represent the MMI of the user input

An MMI can represent both aggregate and ambiguous interpretations within its semantic content. The aggregate operator can be used to relate two or more TFSs when the two or more TFSs are part of a collection of TFSs that are related using the ambiguous operator within a MMFS. This allows nesting of an aggregate set of TFSs within an ambiguous set of TFSs, for example, a user makes a gesture by drawing a circle on a multimodal map application. This gesture may lead to the generation of ambiguous MMIs. It can be interpreted as the selection of an area whose boundaries are provided by the coordinates of the individual points within the gesture. It can also be interpreted as a selection of individual objects within the selected circular area. Let us assume that the only objects within the selected circular area are two hotels. The gesture can be represented as an MMI with aggregate and ambiguous content as shown in Table 4.

TABLE 4
$[ \begin{matrix}Modality \text{:} Gesture \\ start Time \text{:} \text{13:00:01.00, 15 May 2002} \\ end Time \text{: 13:00:02.00, 15 May 2002} \\ content \text{:} ambiguous ( aggregate ( [ \begin{matrix}\begin{matrix}\begin{matrix}\begin{matrix}type \text{:} Hotel \\ Confidence \text{:} 0.7 \\ Reference\_Order \text{:} \\ Name \text{:} Hilton SFO\end{matrix} \\ Address \text{:} [ ]\end{matrix} \\ Rooms \text{:} 255\end{matrix} \\ Rating \text{:} 3\end{matrix} ] , [ \begin{matrix}\begin{matrix}\begin{matrix}\begin{matrix}type \text{:} Hotel \\ Confidence \text{:} 0.7 \\ Reference\_Order \text{:} \\ Name \text{:} Sheraton SFO\end{matrix} \\ Address \text{:} [ ]\end{matrix} \\ Rooms \text{:} 200\end{matrix} \\ Rating \text{:} 4\end{matrix} ] ) , [ \begin{matrix}\begin{matrix}\begin{matrix}\begin{matrix}type \text{:} SelectArea \\ Confidence \text{:} 0.3 \\ Reference\_Order \text{:} \\ Coord \text{:} List (\end{matrix} \\ [ \text{2,3} ] ,\end{matrix} \\ [ \text{1,2} ] ,\end{matrix} \\ [ \text{2,4} ] )\end{matrix} ] )\end{matrix} ]$

The MMIs based on the user inputs for a user turn are collected by the segmentation module 104. The end of a user turn can be determined by, for example, a particular key hit or a particular speech input. The user turn can also be programmed to be of a pre-determined duration. At the end of a user turn, the collected MMIs are sent to the semantic classifier 106. A MMI received by the semantic classifier 106 can be either unambiguous (a single TFS) or ambiguous (list of TFSs). The semantic classifier 106 creates sets of joint MMIs, from the collected MMIs in the order in which they are received from the input modules 102. Each joint MMI comprises MMIs of semantically compatible types. Two MMIs are said to be semantically compatible if there is a relationship between their TFSs, as defined in the taxonomy of the domain model 114 and the task model 115.

The domain model 114 is a collection of concepts within the data processing system 100, and is a representation of the data processing system 100's ontology. The concepts are entities that can be identified within the data processing system 100. The concepts are represented using TFSs. For example, a way of representing a ‘Hotel’ concept can be with five of its properties, i.e., name, address, rooms, amenities, and rating. The properties can be either of an atomic type (string, number, date, etc. ) or one of the concepts defined within the domain model 114. Further, the domain model 114 comprises a taxonomy that organizes concepts into sub-super-concept tree structures. In an embodiment of the invention, two forms of relationships are used to define the taxonomy. These are specialization relationships and partitive relationships. Specialization relationships, also known as ‘is a kind of’ relationship, describe concepts that are sub-concepts of other concepts. For example, in a multimodal navigation application, a ‘StreetAddress’ is a kind of ‘Location’. The ‘is a kind’ of relationship implies inheritance, so that all the attributes of the super-concept are inherited by the sub-concept. Partitive relationships, also known as ‘is a part of’ relationship, describe concepts that are part of (i.e. components of) other concepts. For example, in a multimodal navigation application, ‘Location’ is a part of a ‘Hotel’ concept. The ‘is a part of’ relationship may be used to represent multiple instances of the same contained concept as different parts of the containing concept. Each instance of a contained concept has a unique descriptive name and defines a new attribute within the containing concept having the contained concept's type and the given unique descriptive name. For example, a ‘house’ concept can have multiple components of type ‘room’ having unique descriptive names such as ‘master bedroom’, ‘corner bedroom’, etc.

The task model 115 is a collection of tasks a user can perform while interacting with the data processing system 100 to achieve certain objectives. A task consists of a number of parameters that define the user data required for the completion of the task. The parameters can be either an atomic type (string, number, date, etc.) or one of the concepts defined within the domain model 114 or one of the tasks defined in the task model 115. For example, the task of a navigation system to create a route from a source to a destination via a waypoint will have task parameters as ‘source’, ‘destination’, and ‘waypoint’, which are instances of the ‘Location’ concept. The task model 115 contains an implied taxonomy by which each of the parameters of a task has ‘is a part of’ relationship with the task. The tasks are also represented using TFSs.

The context model 114 comprises knowledge pertaining to recent interactions between a user and the data processing system 100, information relating to resource availability and the environment, and any other application-specific information. The context model 114 provides knowledge about available modalities, and their status to an MMIF module. The context model 114 comprises four major components. These components are a modality model, input history, environment details, and a default database. The modality model component comprises information about the existing modalities within the data processing system 100. The capabilities of these modalities are expressed in the form of tasks or concepts that each input module 102 can recognize, the status of each of the input modules 102, and the recognition performance history of each of the input module 102. The input history component stores a time-sorted list of recent interpretations received by the MMIF module, for each user. This is used for determining anaphoric references. The environment details component includes parameters that describe the surrounding environment of the data processing system 100. Examples of the parameters include noise level, location, and time. The values of these parameters are provided by external modules. For example, the external module can be a Global Position System that could provide the information about location. The default database component is a knowledge source that comprises information which is used to resolve certain references within a user input. For example, a user of a multimodal navigation system may enter an input by saying, “I want to go from here to there”, where the first ‘here’ in the sentence refers to the current location of the user and is not specified by the user using other input modules 102. The default database provides means to obtain to obtain the current location in the form of a TFS of type ‘Location’.

The semantic classifier 106 divides the MMIs collected by the segmentation module 104 for a user turn into a set of joint MMIs, based on semantic compatibility between them. Semantic compatibility between two MMIs is derived from the semantic relationship between their TFSs, which is stored in the domain and task models 113. Two MMIs are semantically compatible if:
1. One of the MMIs is semantically compatible with the other MMI by an ‘is-a-kind-of’ relationship, for example, in a multimodal navigation application, ‘Location’ and ‘StreetAddress’ MMIs are semantically compatible.
2. One of the MMIs is semantically compatible with the other MMI by an ‘is-a-part-of’ relationship, for example, in a multimodal navigation application ‘Location’ and ‘Hotel’ MMIs are semantically compatible.
3. Both the MMIs correspond to the same concept or task.
4. One of the MMIs is a task, and the other is a concept that is a parameter for the task, for example, in a multimodal navigation application, a ‘CreateRouteViaWaypoint’ task has three ‘Location’ attributes representing a source, a destination, and a waypoint as shown in Table 1. Therefore, MMIs representing the ‘CreateRouteViaWaypoint’ task and ‘Location’ concept are semantically compatible.
5. Both the MMIs are semantically compatible with a concept X, such that a concept in the first MMI is a sub-concept of X, and X is-a-part-of a concept in the second MMI, for example, in a multimodal navigation application, a ‘CreateRouteViaWaypoint’ MMI is compatible with a ‘StreetAddress’ MMI, since ‘StreetAddress’ is a sub-type of the ‘Location’ MMI and ‘Location’ MMI is a part of ‘CreateRouteViaWaypoint within the taxonomy of the task model 115.

The semantic classifier 106 divides the collected MMIs into a set of joint MMIs in the following way,

(1) If an MMI is unambiguous, i.e., there is only one MMI generated by an input module 102 for a particular user input, then either a new set of joint MMIs is generated or the MMI is classified into existing sets of joint MMIs. The new set of joint MMIs is generated if the MMI is not semantically compatible with any other MMIs in the existing sets of joint MMIs. If the MMI is semantically compatible to MMIs in one or more existing sets of joint MMIs, then it is added to each of those sets.

(2) If the MMI is ambiguous with one or more TFSs within the ambiguous MMI being semantically compatible to MMIs in one or more sets of joint MMIs, then each of the one or more MMIs in the ambiguous MMI is added to each set of the corresponding one or more sets of joint MMIs containing semantically compatible MMIs, using the following rules:
(a) If the set contains a MMI that is part of the ambiguous MMI, a new set is generated (which is a copy of the current set) and that MMI is replaced with the current MMI in the new set.
(b) If the set does not contain a MMI that is part of the ambiguous MMI, the current MMI is added to that set.

For each of the MMIs within the ambiguous MMI that are not semantically compatible with any existing set of joint MMIs, a new set of joint MMIs is created using the MMI.

(3) If none of the MMI in the ambiguous MMI is related to an existing set of joint MMIs, then for each MMI in the ambiguous MMI a new set of joint MMIs is created using the MMI.

The sets of joint MMIs are then sent to the reference resolution module 108. The reference resolution module 108 generates one set of reference-resolved MMIs for each set of joint MMIs by resolving reference variables present in the MMIs contained in the set of joint MMIs. This is achieved by binding the reference variables to TFSs whose types are the same or sub-types of the type of referents required by the reference variables. For example, when a reference is made to a attribute of type ‘Location’, the attribute is bound to a TFS of type ‘Location’ or one of its sub-types. Deictic reference variables are resolved by using MMIs present within the set of joint MMIs which contains the MMI having the reference variable being resolved. Anaphoric references are resolved, using interpretations from the user input history of the context model 114. In order to resolve such references, the TFSs are searched according to the time at which they are generated, from the most recent to the least recent user turn. If a reference variable is not resolved, the value of the attribute containing the reference variable is replaced with an ‘unresolved’ operator that denotes the reference was not resolved.

The integrator module 110 then generates an integrated MMI for each set of reference-resolved MMIs by integrating multiple MMIs and using semantic operator based fusion. The integrated MMI is generated by the integration of multiple MMIs into a single MMI. The integrator module 110 accepts the sets of reference-resolved MMIs, and performs integration by taking two MMIs at a time. After the first integration, the next MMI in the turn is integrated with the resultant MMI from the previous integration. The integrated MMI can be determined, based on the semantic relationship between the MMIs that are being integrated. In an embodiment of the invention, the final values of the attributes in an integrated MMI are based on the semantic operators present in the values of the corresponding attributes in the corresponding set of reference resolved MMIs.

The integrator module 110 refers to the semantic rule database 112 for the integration process. The semantic rule database 112 comprises the methods to generate results of integrating values that are related by a given semantic relationship function. The integrated MMI, thus generated, contains all the features of the MMIs that are combined. In an embodiment of the invention, the type of an integrated MMI is based on the concept-level relationships of the MMIs in the corresponding set of reference resolved MMIs.

For example, consider two MMIs, X and Y, that are being integrated. There are five possible cases (one for each of the five cases for semantic compatibility described earlier in the description):
1. If X is a sub-concept of Y, then the integrated MMI is of Y's type.
2. If X is a part of Y, then the integrated MMI is of Y's type
3. If X and Y have the same type, then the integrated MMI is of Y's type.
4. If Y corresponds to a task and X is of the same type as a parameter of Y, then the integrated MMI is of Y's type.
5. If X is a sub-type of a concept Z that is part of Y, then the integrated MMI is of Y's type.

The integration of MMIs is carried out with a semantic operator based fusion mechanism. The semantic operator based fusion mechanism is based on a fusion algorithm. The semantic operator based fusion mechanism takes the semantic content of the two MMIs and generates the fused semantic content within an instance of the integrated MMI. The semantic operator based fusion mechanism receives one or more sets of reference resolved MMIs and outputs one integrated MMI for each set of reference resolved MMIs. The semantic operator based fusion mechanism works with attributes that have semantic relationships other than complementary or redundant ones, between their values. The fusion algorithm is described hereinafter.

Let aᵢ denote an attribute in an MMI A and val(aᵢ,A )=vᵢ denote a function that maps the attribute aᵢ to its value vᵢ. vᵢ can be atomic (i.e. string, boolean, number, date, etc.) or a TFS or a semantic operator with either simple or complex values. A value comprising a semantic operator is represented as a function, name(parameters), where name is the semantic operator and parameters is a list of the atomic values or TFSs. For example, in the TFS illustrated in Table. 2, val(Amenties,FS)=list(pool,gym). For this attribute, the name of the semantic operator is list and its parameters are pool and gym.

Let φ represent a null value and dom(A) represent the set of all the attributes in the MMI A. Let semOp(vᵢ) be a function that provides the semantic operator contained in a value, and pars(vᵢ) provides the parameters of that value i.e. semOp(list(pool gym))=list and pars(list(pool,gym))=pool,gym. Nested semantic operators are considered as parameters and do not affect the result of the semOp function.

Let ambiguous represent the semantic operator conveying the meaning that the correct value is uncertain and is possibly one of the values in the list.

Let sem be a function accepting the name of an operator and a list of values. The output of sem is the result of invoking the given semantic operator on the list of values. If the list of values contains nested operators then the function evaluates the result recursively.

Let resolve be a function used to determine the semantic operator to apply when two different semantic operators are present in the two values being combined.

Let SU(A,B)=C denote that semantic operator based fusion between two MMIs, A and B, that results in an MMI C. Then,
1. C's type is the same as that of the integrated MMI of A and B as determined in earlier in the description.
2. If A and B are of the same type, both denote a concept in the domain model 114, and ∀ (aεdom(A)){val(a,A)≠φ, val(a,B)≠φ, semOp(val(a,A)=φ, semOp(val(a,B)=φ}, then C is an integrated MMI containing the semantic contents of A and B related using an ‘aggregate’ operator.
3. If A and B are either of the same type (not satisfying rule 2) or one is a sub-type of other, then
   a. dom(C)=dom(A) ∪ dom(B)
   b. If aεdom(A) and a ε dom(B), and val(a,A)=vA and val(a,B)=vB, then,
      i. If vA=φ and vB=φ, then val(a,C)=φ
      ii. If vA≠and vB=φ, then val(a,C)=vA
      iii. If vA=φ and vB≠φ, then val(a,C)=vB
iv. If vA≠φ and vB≠φ, then,
   1. If vA and vB do not have semantic operators
   a. If both a and b are atomic
   1. If vA≠vB, then val(a,C)=sem(ambiguous, (vA,vB))
   2. If vA=vB, then val(a,C)=vA
   b. If a and b are both complex, then val(a,C)=SU(vA, vB)
   2. If only one of them has a semantic operator in its value, then val(a,C)=sem(semOp(vᵢ, (pars(vᵢ),vj)) where vᵢ is the value with semantic operator, and vj is the other value.
   3. If both vA and vB have semantic operators, then
   a. If semOp(vA)=semOp(vB)≠ambiguous, then val(a,C)=sem(semOp(vA), (pars(vA),pars(vB)))
   b. If semOp(vA)=semOp(vB)=ambiguous, then
   1. If pars(vA) ∩ pars(vB)≠φ, then sem(ambiguous, (pars(vA),pars(vB)))=pars (vA) ∩ pars (vB)
   2. If pars(vA) ∩ pars(vB)=φ, then sem(ambiguo us, (pars (vA),pars (vB)))=ambiguous(pars(vA) U pars(vB))
   c. If semOp(vA)≠semOp(vB), then val(a,C)=sem(resolve(semOp(vA),semOp(vB)), (pars(vA),p ars(vB)))
   c. If a ε dom(A) and a ∉ dom(B), and val(a,A)=vA, then val(a,C)=vA
   d. If a ∉ dom(A) and a ε dom(B), and val(a,B)=vB, then val(a,C)=vB
4. Otherwise, if one MMI is of the same type or the sub-type of a complex attribute in the other MMI, for example, if A is of the same type or sub-type of a complex attribute b in B, then
   a. dom(C)=dom(A) ∪ (dom(B)-dom(type of attribute b))), this allows C to have the features of a sub-type of a complex attribute
   b. If semOp(val(b,B))=φ then val(b,C)=SU(A,val(b,B))
   c. If semOp(val(b,B))≠φ, then val(b,C)=sem(semOp(val(b,B)), (pars (val(b,B),A))

The time related features of the integrated MMI are set such that they cover the duration of the two MMIs that are integrated, i.e., the ‘start time’ attribute is set to the earlier of the ‘start time’ attributes in the two MMIs, and the ‘end time’ attribute is set to the later of the ‘end time’ attributes of the two MMIs.

The second rule of semantic operator based fusion is useful in conditions where, for example, the user of a multimodal map application gestures twice to provide two locations on the map. In such a case, the integrated MMI generated is an aggregate MMI consisting of the two ‘Location’ MMIs generated, corresponding to the two gestures.

The fusion algorithm does not operate on an ambiguous MMI since it is split into constituent MMIs by the semantic classifier 106. However, the input for the integration process with the fusion algorithm can be an aggregate MMI. If one or both of the MMIs being integrated are aggregate MMIs, the integration process breaks the aggregate MMIs into constituent TFSs. The integration process integrates all the possible pairs of constituent TFSs, taking one from each aggregate MMI. The set of MMIs resulting from the integration are then put within an aggregate semantic relationship function and set as the content of the integrated MMI.

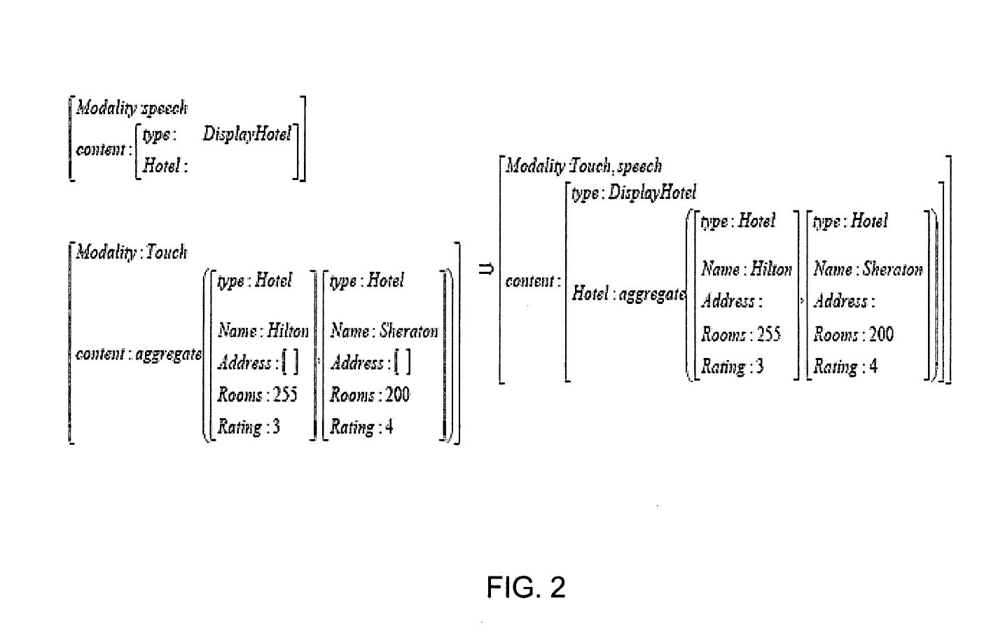

While integrating two MMIs, based on fusion algorithm, if the common attributes in the two MMIs have different semantic operators in their values, the confidence scores of the MMIs and precedence rules are used to determine the semantic operator that should be applied for integration. First, the confidence scores of the integrating MMIs are compared, and if the score of one of the MMIs is significantly higher (>50%) then the semantic operator corresponding to the MMI with the higher confidence score is applied. If the confidence scores are not significantly different, and only one of the MMIs is of the same type as the integrated MMI, then the semantic operator in that MMI is applied. If both the MMIs are of the same type, a fixed precedence order of the operators is used to resolve the conflict. The operator appearing earlier on the precedence list takes precedence over semantic relationship functions that appear later on in the list. In an embodiment of the invention, the list is ordered as ‘Replace’, ‘Not’, ‘And’, ‘Or’, ‘Aggregate’, ‘List’, and ‘Ambiguous’. If a Dialog Manager (DM) can support disambiguation through further dialog, an ambiguous value is generated consisting of the results of applying each of the two operators individually. The disambiguation of the correct value is deferred to the DM through further interaction. The DM is responsible to determine the user's intention after taking the set of integrated MMIs generated by the MMIF module. The DM takes appropriate action based on its determination of the user's intention such as requesting the system to perform the requested task or asking the user to provide further information in order for the system to perform the requested task. If the DM wants to disambiguate the correct value for an attribute of an integrated MMI, it will query the user to get the correct value. The integration process is further explained with the help of FIGS. 2, 3, 4 and 5.

Referring to FIG. 2, the integration of an MMI with the aggregate content of type ‘Hotel’ with an MMI of type ‘DisplayHotel’ is shown. The ‘Hotel’ MMI is an aggregate of two TFSs of type ‘Hotel’. Each ‘Hotel’ MMI has attributes such as type, name, address, rooms and rating. The ‘DisplayHotel’ MMI has an attribute called ‘Hotel’, the value of which is substituted by the aggregate MMI in the integration process.

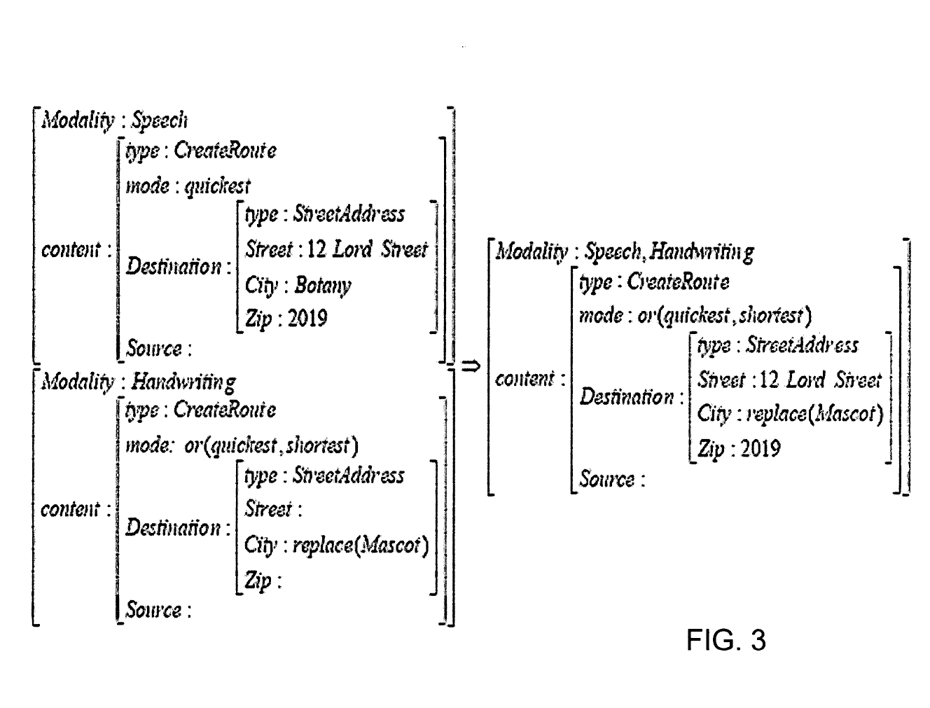

Referring to FIG. 3, the integration of two ‘CreateRoute’ MMIs with semantic operators is shown. One ‘CreateRoute’ MMI is generated, corresponding to each speech and handwriting modalities. Each ‘CreateRoute’ MMI has attributes such as type, mode, destination and source. The ‘CreateRoute’ MMI generated by the handwriting input modality has semantic operators as value to the mode attribute and the city attribute of a TFS of type ‘StreetAddress’. The semantic operator is applied in the values of the attributes in the integrated MMI.

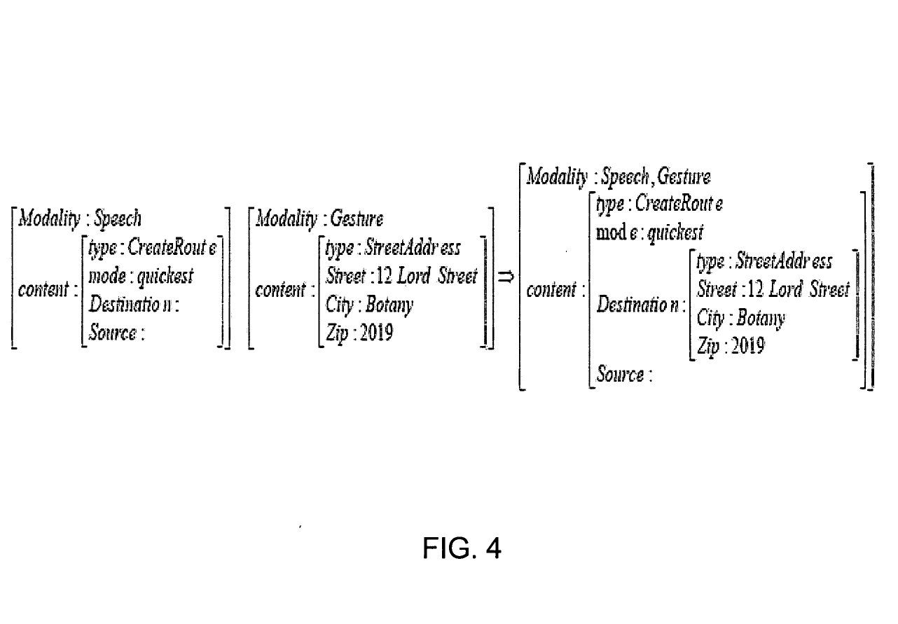

Referring to FIG. 4, the integration of a ‘CreateRoute’ MMI with a ‘StreetAddress’ MMI, which is a sub-type of a complex attribute of the ‘CreateRoute’ MMI is shown. The ‘CreateRoute’ MMI has attributes such as type, mode, source and destination. The destination attribute is a complex attribute of type ‘Location’. The ‘StreetAddress’ MMI has attributes such as type, street, city and zip. The type ‘StreetAddress’ is a sub-type of type ‘Location’. In the integration of these two MMIs by fusion algorithm, the value of the destination attribute is substituted by the ‘StreetAddress’ MMI.

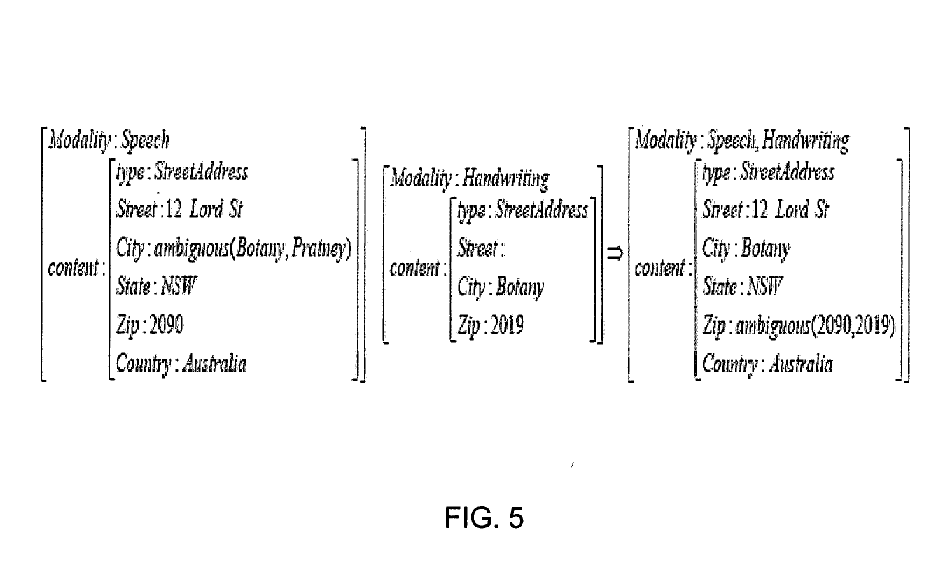

Referring to FIG. 5, the ambiguity resolution of an atomic attribute when two MMIs are integrated is shown. Two ‘StreetAddress’ MMIs are generated, corresponding to user inputs in different modalities. The MMIs have an atomic attribute called ‘City’. Its value is different in both the MMIs thereby resulting in ambiguity. The value of the ‘City’ attribute in the ‘StreetAddress’ MMI generated in speech input modality is a semantic operator based function ‘ambiguous’. There is an ambiguity between the cities Botany and Pratney. In case of the ‘StreetAddress’ MMI generated in the handwriting input modality, the value of the ‘City’ attribute is Botany. Therefore, in accordance with the fusion algorithm, the value of the ‘City’ attribute is set to Botany. Further, since the values of the ‘Zip’ attribute are different in both the MMIs, the integrated MMI has an ambiguous value for the ‘Zip’ attribute.

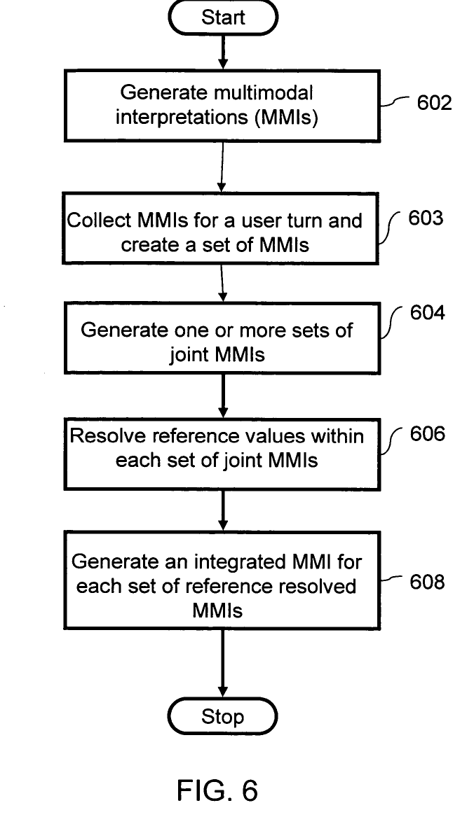

Referring to FIG. 6, a flowchart illustrates some steps of a method for integrating MMIs, in accordance with some embodiments of the present invention and some of the details described herein above. At step 602, MMIs, based on each user inputs, are generated. In an embodiment of the invention, the MMIs are generated by the input modules 102. At step 603, the generated MMIs are collected to create a set of MMIs for a user turn. In an embodiment of the invention, the set of MMIs is created by the segmentation module 104. At least one MMI in the set of MMIs includes at least one semantic relationship function. The semantic relationship function denotes a semantic relationship between values determined by user inputs entered through one or more input modality. Further, the semantic relationship function includes at least one semantic operator. At step 604, one or more sets of joint MMIs are generated by using the set of MMIs generated at step 603. In an embodiment of the invention, the sets of joint MMIs are generated by the semantic classifier 106. Each set of joint MMIs comprises one or more MMIs of semantically compatible types. At step 606, the reference values within each set of joint MMIs are resolved to generate corresponding sets of reference resolved MMIs. In an embodiment of the invention, the reference values are resolved by the reference resolution module 108. At step 608, an integrated MMI is generated for each set of reference resolved MMIs. In an embodiment of the invention, the integrated MMI is generated by the integrator module 110. The integrated MMI is generated by using semantic operator based fusion. In an embodiment of the invention, generating an integrated MMI by means of semantic operator based fusion comprises generating an integrated MMI of an aggregate type for a set of reference resolved MMIs. This is when all MMIs in the corresponding set of reference resolved MMIs are of the same concept type, and include no semantic relationship function, and wherein all features in the corresponding set of reference resolved MMIs have non-empty values.

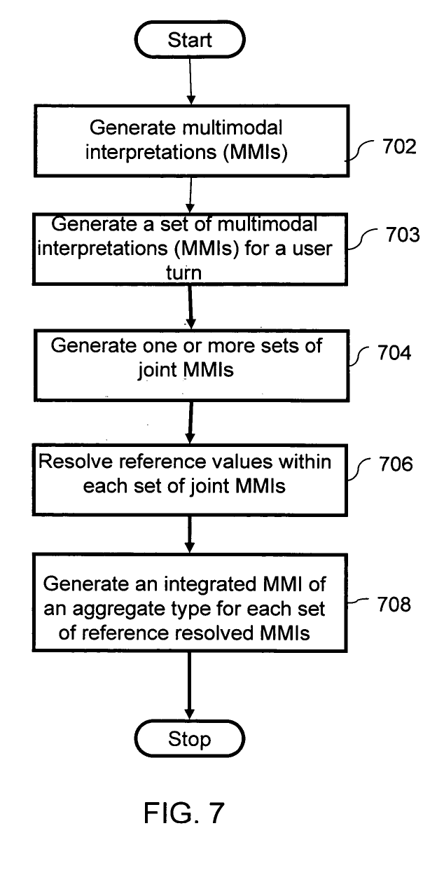

Referring to FIG. 7, a flowchart illustrates some steps of a method for generating an aggregate type integrated MMI in a data processing system 100 in which semantic operators are not used, in accordance with some embodiments of the present invention and some of the details described herein above. At step 702, MMIs based on the user inputs are generated. At step 703, the generated MMIs are collected to create a set of MMIs for a user turn. The MMIs in the generated set of collected MMIs does not include any semantic relationship function. Further, a semantic operator is not present in any MMI in the generated set of MMIs. At step 704, one or more sets of joint MMIs are generated by using the set of MMIs generated at step 703. Each set of joint MMIs comprises one or more MMIs of semantically compatible types. At step 706, the reference values within each set of joint MMIs are resolved to generate corresponding sets of reference resolved MMIs. At step 708, an integrated MMI of an aggregate type is generated for each set of reference resolved MMIs. The integrated MMI is generated when all MMIs in a corresponding set of reference resolved MMIs are of the same concept type, and wherein all the features in the set of reference resolved MMIs have non-empty values.

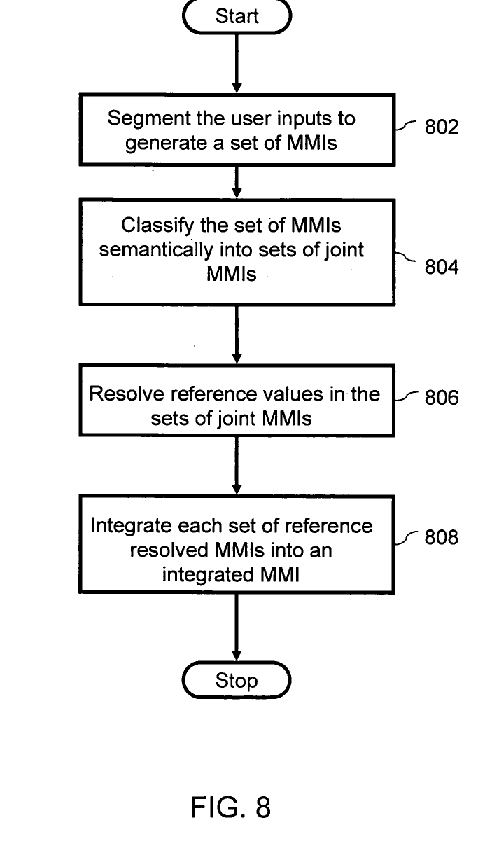

Referring to FIG. 8, a flowchart illustrates some steps of yet another method for integrating MMIs, in accordance with some embodiments of the present invention and some of the details described herein above. The user inputs to the data processing system 100 are segmented at step 802. Segmenting the user inputs comprises collecting a set of MMIs corresponding to the user inputs for a user turn. The collected set of MMIs is then classified semantically at step 804. Semantically classifying the collected set of MMIs comprises dividing the set of MMIs into a set of joint MMIs. Each set of joint MMIs comprises MMIs that are of a semantically compatible type. The reference values in each set of joint MMIs are resolved at step 806 to generate corresponding sets of reference resolved MMIs. Resolving the reference values comprises binding the reference variables present in the references to a TFS, the type of which either matches or is a sub-type of the type of the referent required by the reference variable. Next, at step 808, each set of reference resolved MMIs, comprising MMIs with resolved reference values, are integrated to generate a corresponding set of integrated MMIs.

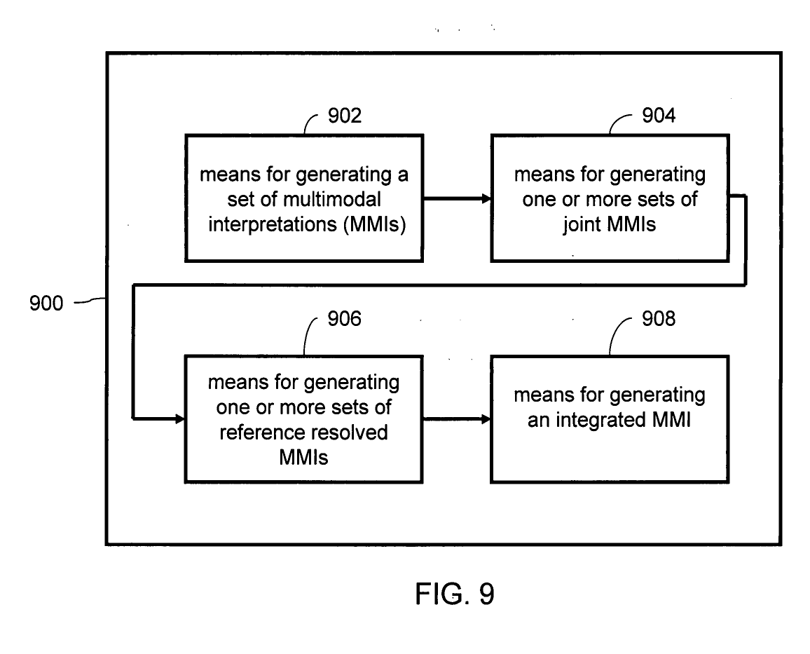

Referring to FIG. 9, an electronic device 900, for integration of MMIs, is shown, in accordance with some embodiments of the present invention and some of the details described herein above. The electronic device 900 comprises a means for generating 902 a set of MMIs based on the user inputs collected during a turn. Further, the electronic device 900 comprises a means for generating 904 one or more sets of joint MMIs, based on the set of MMIs. Further, the electronic device 900 comprises a means for generating one or more sets of reference resolved MMIs by resolving 906 reference values within the one or more sets of joint MMIs. The electronic device 900 also comprises a means for generating 908 an integrated MMI for each set of reference-resolved MMIs. The integrated MMI is generated by using semantic operator based fusion.

The technique of integration of MMIs as described herein can be included in complicated systems, for example a vehicular driver advocacy system, or such seemingly simpler consumer products ranging from portable music players to automobiles; or military products such as command stations and communication control systems; and commercial equipment ranging from extremely complicated computers to robots to simple pieces of test equipment, just to name some types and classes of electronic equipment.

It will be appreciated that the integration of MMIs technique described herein may be comprised of one or more conventional processors and unique stored program instructions that control the one or more processors to implement some, most, or all of the functions described herein; as such, the functions of generating a set of MMIs and resolving the reference values of the references may be interpreted as being steps of a method. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

In the foregoing specification, the present invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

A “set” as used herein, means an empty or non-empty set. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for integrating multimodal interpretations (MMIs) generated from user inputs to a data processing system, the user inputs being entered through at least one input modality, the method comprising:
generating a set of MMIs based on the user inputs for a user turn, at least one MMI comprising at least one semantic relationship function, the semantic relationship function denoting a semantic relationship between values determined from the user inputs entered through one or more of the at least one input modality, the semantic relationship function comprising at least one semantic operator;
generating one or more sets of joint MMIs by using the generated set of MMIs, each set of joint MMIs comprising one or more MMIs of semantically compatible types;
resolving reference values within each set of joint MMIs to generate corresponding sets of reference resolved MMIs; and
generating an integrated MMI for each set of reference resolved MMIs by using semantic operator based fusion.

2. The method according to claim 1, wherein generating the integrated MMI by semantic operator base fusion comprises:
determining the type of an integrated MMI that will be generated, based on the concept level relationships of the MMIs in the corresponding set of reference resolved MMIs;
determining final values of features in the integrated MMI based on the semantic operators present in values of corresponding features in the corresponding set of reference resolved MMIs.

3. The method according to claim 1, wherein generating the integrated MMI by semantic operator based fusion comprises generating an integrated MMI of an aggregate type for a set of reference resolved MMIs when all MMIs in the corresponding set of reference resolved MMIs are of a same concept type, and include no semantic relationship function, and wherein all features in the corresponding set of reference resolved MMIs have non-empty values.

4. The method in accordance with claim 1 further comprising generating a Multimodal structure (MMFS) for each MMI in the generated set of MMIs, the MMFS comprising at least one semantic operator.

5. The method in accordance with claim 1 wherein, generating the set of MMIs comprises setting a value of an attribute present in the MMI to a semantic relationship function.

6. The method in accordance with claim 1 wherein the MMIs of semantically compatible types are related by a concept level relationship that is one of a ‘is a kind of’ and ‘is a part of’ relationship.

7. The method in accordance with claim 1 wherein the semantic relationship function is selected from the group consisting of ‘and’, ‘or’, ‘not’, ‘list’, ‘aggregate’, ‘ambiguous’ and ‘replace’ relationship functions.

8. The method in accordance with claim 1 wherein, the semantic relationship function is a content level relationship.

9. The method in accordance with claim 8 wherein, an MMI corresponding to the content-level relationship comprises at least one of a complimentary interpretation, a redundant interpretation, a logical interpretation and an overlaying interpretation.

10. The method in accordance with claim 2 wherein, each TFS comprises at least one attribute-value pair, each attribute being one of an atomic attribute and a complex attribute, the atomic attribute being one of a group consisting of an empty value, one or more atomic values and a semantic relationship function, and the complex attribute being one of a group consisting of an empty value, one or more complex values, a reference variable and a semantic relationship function.

11. A method for integrating multimodal interpretations (MMIs) generated from user inputs to a data processing system, the user inputs being entered through at least one input modality, the method comprising:
segmenting the user inputs by collecting sets of multimodal interpretations (MMIs) corresponding to the user inputs for a user turn, at least one MMI comprising at least one semantic relationship function the semantic relationship function denoting a semantic relationship between values determined from the user inputs entered through one or more of the at least one input modality, the semantic relationship function comprising at least one semantic operator;
semantically classifying the collected MMIs to generate sets of joint MMIs, wherein each set of joint MMIs comprises MMIs of semantically compatible types;
generating one or more sets of reference resolved MMIs by resolving the reference variables in the sets of joint MMIs, wherein resolving the reference variables refers to replacing each reference variable with a resolved value; and
integrating each set of reference resolved MMIs to generate a corresponding set of integrated MMIs by using semantic operator based fusion.

12. A data processing system for integrating multimodal interpretations (MMIs) generated from user inputs to the data processing system, the user inputs being entered through at least one input modality, the data processing system generating MMIs based on each user input, the data processing system comprising:
a segmentation module, the segmentation module collecting a set of MMIs corresponding to the user inputs for a user turn, at least one MMI comprising at least one semantic relationship function the semantic relationship function denoting a semantic relationship between values determined from the user inputs entered through one or more of the at least one input modality, the semantic relationship function comprising at least one semantic operator;
a semantic classifier, the semantic classifier semantically classifying the set of MMIs to generate sets of joint MMIs, wherein each set of joint MMIs comprises MMIs of semantically compatible types;
a reference resolution module, the reference resolution module generating one or more sets of reference resolved MMIs by resolving the reference variables in the sets of joint MMIs, wherein resolving the reference variables refers to replacing each reference variable with a resolved value; and
an integrator module, the integrator module integrating each set of reference resolved MMIs to generate a corresponding set of integrated MMIs by using semantic operator based fusion.

13. An electronic equipment that integrates multimodal interpretations (MMIs) generated from user inputs to a data processing system, the user inputs being entered through at least one input modality, the equipment comprising:
means for generating a set of MMIs based on the user inputs for a user turn, at least one MMI comprising at least one semantic relationship function, the semantic relationship function denoting a semantic relationship between values determined from the user inputs entered through one or more of the at least one input modality, the semantic relationship function comprising at least one semantic operator;
means for generating one or more sets of joint MMIs by using the generated set of MMIs, each set of joint MMIs comprising one or more MMIs of semantically compatible types;
means for resolving reference values within each set of joint MMIs to generate corresponding sets of reference resolved MMIs; and
means for generating an integrated MMI for each set of reference resolved MMIs by using semantic operator based fusion.

14. A computer program product for use with a computer, the computer program product comprising a computer usable medium having a computer readable program code embodied therein for integrating multimodal interpretations (MMIs) generated from user inputs to a data processing system, the user inputs being entered through at least one input modality, the computer program code including functions for:
generating a set of MMIs based on the user inputs for a user turn, at least one MMI comprising at least one semantic relationship function, the semantic relationship function denoting a semantic relationship between values determined from the user inputs entered through one or more of the at least one input modality, the semantic relationship function comprising at least one semantic operator;
generating one or more sets of joint MMIs by using the generated set of MMIs, each set of joint MMIs comprising one or more MMIs of semantically compatible types;
resolving reference values within each set of joint MMIs to generate corresponding sets of reference resolved MMIs; and
generating an integrated MMI for each set of reference resolved MMIs by using semantic operator based fusion.

15. A method for integrating multimodal interpretations (MMIs) generated from user inputs to a data processing system, the user inputs being entered through at least one input modality, the method comprising:
generating a set of MMIs based on the user inputs for a user turn;
generating one or more sets of joint MMIs by using the generated set of MMIs, each set of joint MMIs comprising one or more MMIs of semantically compatible types;
resolving reference values within each set of joint MMIs to generate corresponding sets of reference resolved MMIs; and
generating an integrated MMI of an aggregate type for each set of reference resolved MMIs when all MMIs in a corresponding set of reference resolved MMIs are of a same concept type and wherein all features in the set of reference resolved MMIs have non-empty values.
